(19) United States
(12) Patent Application Publication
(10) Pub. No.: US 2009/0285378 A1
(43) Pub. Date: Nov. 19, 2009

(54) SYSTEM AND METHOD FOR OBFUSCATING CONTACT NUMBERS

(76) Inventors: Krishna Leela Poola, Bangalore (IN); Kalyan Kumar Kanuri, Bangalore (IN)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/121,445

(22) Filed: May 15, 2008

(51) Int. Cl. H04M 3/42; H04Q 7/20

(52) U.S. Cl. 379/201.11; 455/466

(57) ABSTRACT

A system for managing and tracking contacts between businesses and prospective customers, where the customer typically calls or sends a text message to the business on a mobile telephone. A business registered with the system is assigned a temporary, dynamic contact number (obfuscated number). A customer interacts with the business through the system using the obfuscated number; the customer's number is not revealed to the business. Usage of the obfuscated number is tracked and analyzed to yield marketing information for the business. Expiration of the number may be delayed if the parties continue to maintain contact.

### FIELD OF THE DISCLOSURE

This disclosure relates to a system for managing and tracking contacts between businesses and customers, particularly in situations where the customer communicates by mobile telephone or by text messaging.

### BACKGROUND OF THE DISCLOSURE

Many business try to attract customers by inviting prospective customers to call them on the telephone (or, more recently, send a text message by a Short Message System (SMS)). This generally has the effect of publishing the prospective customer's contact number to the business. This may require storing the customer's contact number, perhaps for an indefinite period of time. This could be at odds with a customer's desire for privacy.

### SUMMARY OF THE DISCLOSURE

There are applications where communications are more effective if conducted through a secure channel. In particular, it is desirable to implement secure communications between customers and businesses where the customer uses a mobile phone to make calls or send text messages.

The present disclosure provides a system and method for facilitating communication between two parties, such as a business (advertiser) and a customer. According to a first aspect of the disclosure, a method comprises transmitting a search request to a service provider comprising a user query for contact information for a business provider; receiving a result from the service provider comprising a contact number and content related to the business provider, the contact number being different from a true contact number for the business provider; connecting with the business provider via the service provider using the different contact number, wherein the service provider establishes the connection between a user and the business provider; and communicating with the business provider, the communication being analyzed by the service provider.

According to another aspect of the invention, a method comprises receiving at a service provider a contact request from a first party and a second party, wherein the first party and the second party each reveal true contact information, the request pertaining to a distribution of content; assigning a transactional contact number to the second party that is different from the true contact information of the second party for use by the first party to establish communication between the parties; assigning an expiration time for the transactional contact number based upon the request; facilitating a connection between the first party and the second party, wherein the first party utilizes the transactional contact number to contact the second party at least in part via the service provider; and receiving information related to the communication between the parties to obtain outcome information regarding an outcome of a transaction, wherein the true contact information of either party is not disclosed to either party by the service provider.

According to an aspect of the disclosure, a computer-readable medium tangibly encoding instructions for performing a method, comprises receiving at a service provider a contact request from a first party and a second party, wherein the first party and the second party each reveal true contact information, the request pertaining to a distribution of content; assigning a transactional contact number to the second party that is different from the true contact information of the second party for use by the first party to establish communication between the parties; assigning an expiration time for the transactional contact number based upon the request; facilitating a connection between the first party and the second party, wherein the first party utilizes the transactional contact number to contact the second party at least in part via the service provider; and receiving information related to the communication between the parties to obtain outcome information regarding an outcome of a transaction, wherein the true contact information of either party is not disclosed to either party by the service provider.

According to another aspect of the disclosure, a system comprises a plurality of processors; a service provider server for receiving a contact request from a first party and a second party, wherein the first party and the second party each reveal true contact information, the request pertaining to a distribution of content; a contact number assignment engine implemented on one of the plurality of processors for assigning a transactional contact number to the second party that is different from the true contact information of the second party for use by the first party to establish communication between the parties; the contact number assignment engine implemented on one of the plurality of processors for assigning an expiration time for the transactional contact number based upon the request; the service provider server for facilitating a connection between the first party and the second party, wherein the first party utilizes the transactional contact number to contact the second party at least in part via the service provider server; and a monitoring engine implemented on one of the plurality of processors for receiving information related to the communication between the parties to obtain outcome information regarding an outcome of a transaction, wherein the true contact information of either party is not disclosed to either party by the service provider server.

Additional features of the disclosure will be described hereinafter that form the subject of the claims of the disclosure. Those skilled in the art should appreciate that they can readily use the disclosed embodiments as a basis for designing or modifying other structures for carrying out the same purposes of the present disclosure and that such other structures do not depart from the spirit and scope of the disclosure in its broadest form.

It is to be understood that both the foregoing general description and the following detailed description are exemplary and explanatory and are intended to provide further explanation of the disclosure as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 is a schematic illustration of an embodiment of an architecture for facilitating an interaction between a contact system provider, a customer (typically using a mobile phone) and a business advertising to the customer.

FIG. 2 is a flowchart illustrating one embodiment of a process for facilitating an exchange between parties.

FIG. 3 is a flowchart illustrating one embodiment of setting and managing an expiration date of an obfuscated contact number.

FIG. 4 is a flowchart illustrating one embodiment of steps in an interaction between a business and a user in which an obfuscated contact number is used, facilitated by a system.

FIGS. 5A and 5B show examples of text messages in an interaction between a user and a system.

FIG. 6 is a flowchart illustrating one embodiment of steps in a process for mining the context of a transaction between an advertiser and a user.

FIG. 7 is a schematic illustration of an embodiment of an architecture for facilitating an interaction between a service exchange, a user and a business service provider.

### DETAILED DESCRIPTION

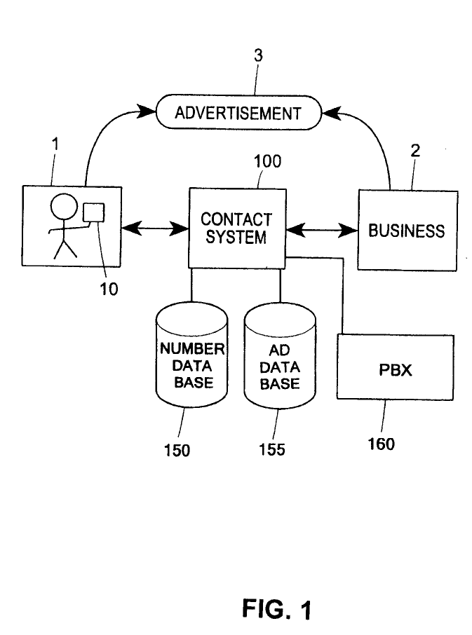

An interaction between a user 1 and a business 2, facilitated by a system 100 embodying the present disclosure, is schematically illustrated in FIG. 1. The business advertises its goods/services through any of a variety of media (print, billboards, the Internet, etc.). The advertisement 3 invites the user 1 to contact business 2, typically by placing a telephone call or sending a text message via a SMS. User 1 responds to the advertisement by making a contact, for example with mobile telephone 10. As shown in FIG. 1, system 100 provides contact with both user 1 and business 2, but the user and business do not directly contact each other. All contacts are carried out using dynamically assigned, time-limited obfuscated contact numbers, as detailed below. The mapping between the actual telephone numbers and the dynamic contact number is stored on database 150, along with other data relevant to the transaction between user 1 and business 2. Another database 155 stores advertisements that business 2 may wish to serve to prospective customer 1 after a telephone or SMS contact is made.

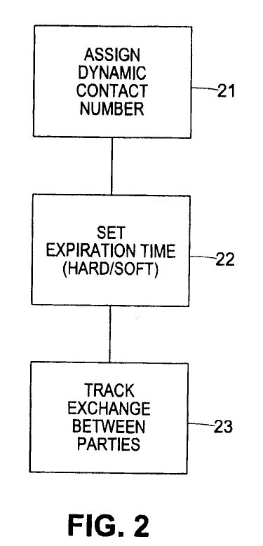

As shown in FIG. 2, system 100 facilitates a transaction between parties (for example, the user and a business placing the advertisement) by assigning the dynamic contact number, setting an expiration time for the contact number, and tracking the exchange between the parties.

A pool of available contact numbers is maintained in database 150. When user 1 contacts the system (for example, by calling a telephone number of business 2 appearing in advertisement 3), a selected number from the pool is assigned to the user (step 21). This number (dynamic contact number or obfuscated number) may be selected at random, or may be selected using another allocation strategy depending on privacy requirements. For example, one such intelligent allocation strategy could be not to assign the same dynamic number assigned to the particular user in the previous N allocations.

Assignment of the dynamic contact number may be implemented with an existing telephone network using a private branch exchange (PBX) 160. As understood by those skilled in the art, a PBX manages a pool of phone numbers where the first few digits will be common but the last few digits vary. The number of varying digits will depend on number of available connections; typically this number is 4, which means that 10,000 unique numbers can be assigned from a PBX.

Every assigned dynamic contact number is tagged with a time limit (step 22), after which the contact expires (that is, the number is no longer usable for a transaction between user 1 and advertiser 2). The lifetime of the contact number may depend on several factors, as described in further detail below. Expiration of the number may be “soft” (some extension of time permitted) or “hard” (no extension of time permitted), depending on the history and context of the transaction.

The parties (e.g. user 1 and advertiser 2) communicate using the dynamic contact numbers. Accordingly, all conversations between the parties goes through a service provider channel maintained by system 100. System 100 tracks the exchange between the parties (step 23), and extracts business data therefrom. While it is not necessary to track most of the conversations between the parties, businesses would find it desirable to track details such as the time and place of the user's contact, whether the deal was successful, and so forth. For example, a service exchange connecting service providers and customers would want to know the status of the deal in order to charge the service provider an appropriate commission.

In an embodiment, a call from the user directed to a business will be either forwarded or proxied, depending on privacy settings established when the customer is assigned the dynamic contact number. In the case of call forwarding the system 100 will not perform a tracking function. In the case of proxying, the conversations of a party are routed through the system 100 so that the system acts as a voice proxy. Once the conversation is finished, the system may perform tracking by taking input from a user about the success of the transaction with DTMF key inputs (e.g. prompting the user to “press 1 for a successful transaction”).

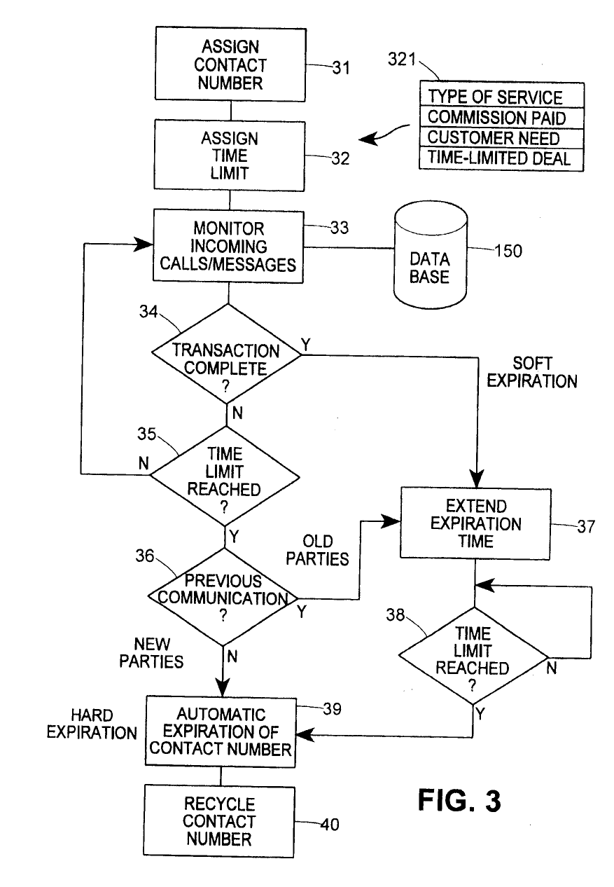

In some embodiments, the contact numbers are dynamically assigned, given a limited lifetime, and then recycled (made available for reassignment to a different user). A procedure for managing the lifetime of a contact number, including “soft” and “hard” expiration in accordance with an embodiment of the disclosure, is shown schematically in FIG. 3. A contact number is assigned to a party to the transaction (step 31). The time limit (or expiration time) for the number is assigned (step 32) based on a number of possible factors 321, including but not limited to the type of service advertised, the commission paid by the advertiser, the lifetime of the customer need, time limitations on the business deal itself, etc. For example, if a customer needs to see a dentist in the next two hours, assigning a dynamic contact number with a lifetime much longer than two hours will not serve the purpose. Similarly, if a customer needs a ticket for a show in the evening, assigning a dynamic contact number with a lifetime past the present date will not serve the purpose.

The system 100 monitors the progress of a transaction between the parties (step 33). Various items of information (the “context” of the transaction) are extracted and stored in database 150, using a procedure described in more detail below.

The dynamic contact number expires at the end of the assigned time limit; however, there may be situations in which the parties are still actively working on concluding a transaction. If a transaction is not complete (step 34), but the assigned time limit is reached (step 35), the system determines whether the parties have already communicated with the system using the contact number before expiration (step 36). If the parties are “Old Parties,” meaning that they have previously communicated, the expiration of the contact number is treated as a “soft” expiration, and the lifetime of the contact number is extended (step 37). In an embodiment, when a transaction completes successfully the expiration of the dynamic contact number is treated as a soft expiration by default.

Soft expiration will become hard expiration, even for old parties (step 38), after a sufficient amount of time dictated by various factors as described above. If the parties are “New Parties” and have not communicated during the lifetime of the contact number, the number expires automatically (step 39), and the new parties cannot communicate with the expired contact number. After some convenient interval of time, the assigned number(s) are recycled; that is, assigned to a new user for a different transaction (step 40). The assigned number(s) may be recycled automatically in some embodiments.

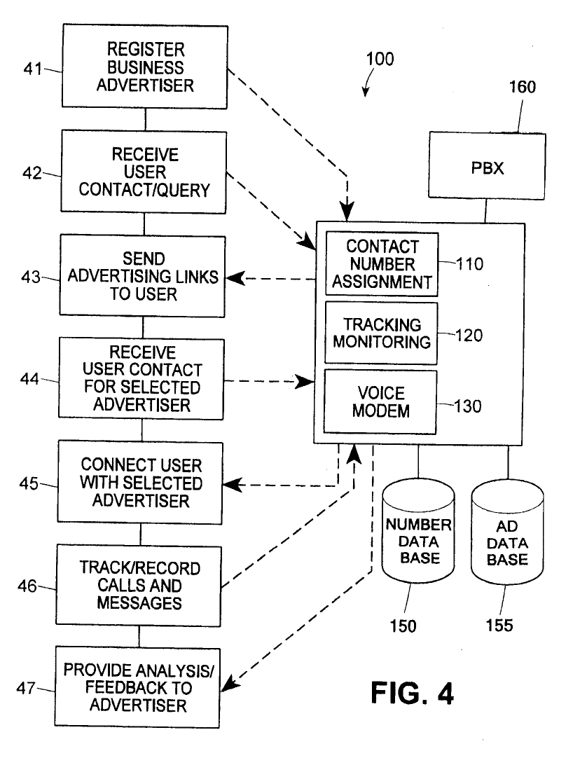

A scenario for an interaction between a user and an advertiser through system 100 is shown schematically in FIG. 4. In an embodiment, system 100 includes a voice modem 130 for routing calls to a computer; a contact number assignment engine 110; and a tracking/monitoring engine 120. The contact number assignment engine and tracking/monitoring engine are realized as software (executable code) typically stored on a computer-readable storage medium and executed on a computing device. It will be appreciated that such code may be resident on a stand-alone computer or be obtained by downloading from a network such as the Internet. Assignment of the dynamic contact number may be implemented with an existing telephone network using PBX 160. Data that flows to and from the system are schematically illustrated by the dashed lines in FIG. 4.

In step 41, an advertiser registers with the system provider; the advertiser reveals his actual contact information to the system provider, but this information is not revealed to users of the system (customers). In step 42, a user makes contact with the system, either via SMS or a telephone call. The user may be responding to an advertisement, or making a query regarding desired goods or services. If the user is responding to a specific advertisement, the system sends the user a contact number for that advertiser. If the user made a more general query, the system sends back to the user a list of advertiser links, (for example, those advertisers that are top ranked or that have paid for placement in a search result by keyword) and phone numbers (step 43). It should be noted that the numbers of the advertisers are also preferably obfuscated.

In step 44, the user interacts with a selected one of the advertiser contact phone numbers provided by the system. The lifetime of the dynamic contact number assigned to the advertiser can be made to depend on the context of the request, advertiser pricing and/or various other factors, or be a fixed default time. The user's phone number is not revealed to the advertiser. The system connects the dialed-in user with the actual phone number of the advertiser (step 45). The calls and/or messages thus exchanged between the user and the advertiser are tracked and recorded (step 46). The content of the call may be analyzed, for example, for additional leads. The system may then charge the advertiser for each lead, or per successful lead. Additional data regarding the transaction is stored, analyzed and reported to the advertiser (step 47).

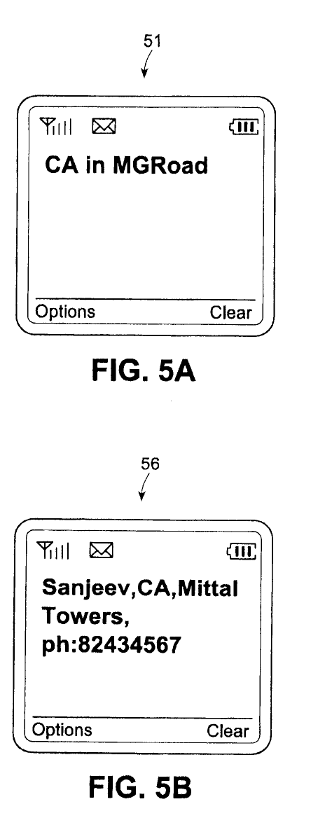

Examples of a user query 51 and a system response 56 are shown in FIGS. 5A and 5B respectively. In FIG. 5A, a user needing the services of a chartered accountant (“CA”) at a convenient location (“MG Road”) sends this query to the system as a text message from his mobile phone. The system responds with contact information for a top-ranked advertiser (for example, an advertiser or a list of multiple advertisers from which one may be chosen, and ranked according to distance from the querying user, advertising fee paid, and/or other factors). An obfuscated contact phone number is included in the system message 56. The user may then call the displayed number to make contact with the advertiser. The user's call is actually directed to the system 100, which then routes the call to the advertiser using the advertiser's stored contact information.

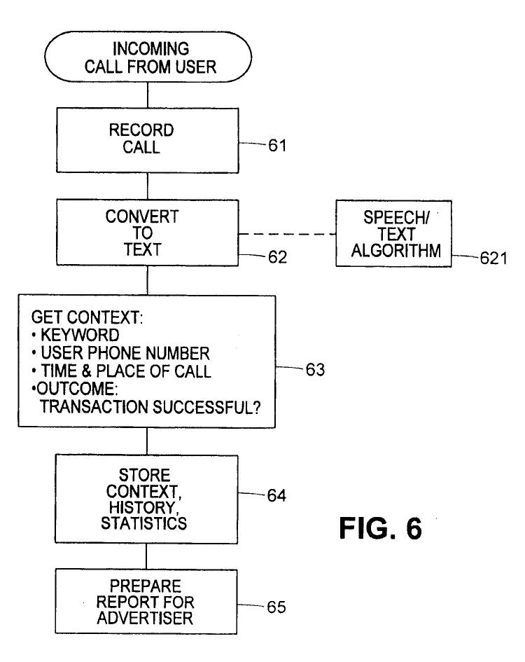

A procedure for extracting information from the user/advertiser transaction is shown schematically in FIG. 6. The incoming call from the user is recorded by the system (step 61). The content of the call is converted to text (step 62) using a speech/text algorithm 621. (Alternatively, the content of an incoming text message is recorded as text by the system.) This text is then mined (step 63) for the context of the transaction: for example, the advertising keyword used to elicit the user's query, the user's phone number, the time and place of the user's call, and the outcome of the transaction (whether or not it was successful). This information is stored along with all other information from tracking the transaction (step 64), and then analyzed and reported to the advertiser (step 65) as an additional paid service.

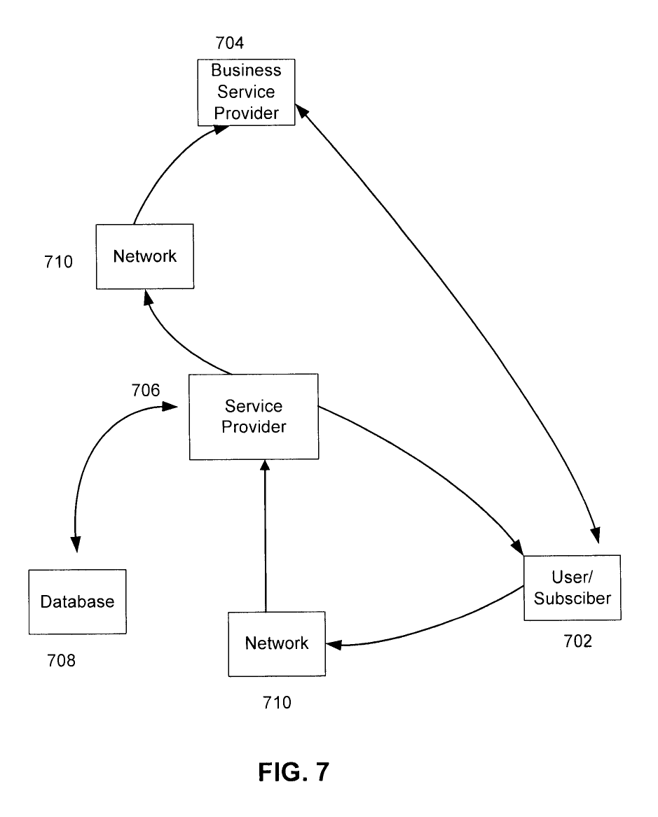

An interaction between a service exchange 706, a user (service seeker or customer) 702 and a business service provider (advertiser) of the present disclosure is schematically illustrated system 700 in FIG. 7. Between the user 702 and the business service provider 704, a transparent call is established between these two parties via the service exchange 706. The service exchange 706 may be realized via companies or providers that enable the transferring of data or content over any type of network. These companies or providers may include Yahoo!, or other web service provider, or all other types of data service providers engaging in the transfer of information. The service exchange 706 provides obfuscation, proxying, monitoring, etc. upon acting as a hub between the user 702 and the business service provider 704, as described above. The service exchange 706 interacts with the business service provider 704 and the user 702 via network(s) 710. The transmissions between within the system 700 may be that of a phone call, SMS, web request, etc, which are transmitted through network 710, which may embody a PSTN, Internet, intranet, VOIP, etc. The service exchange 706 stores the following information while serving the user 702 requested contact numbers: contact number of the user (Cu), advertiser obfuscated contact number (Oa), advertiser original contact number (Ca). The service provider interacts with database 708 which stores and exchanges stored information with the service exchange 706 such as publishers, subscribers, advertisements and context of obfuscated contact numbers, user contact information, business provider contact information, and all other information which can be utilized within the system for providing the customer and business a secure and private connection.

By way of a non-limiting example, an embodiment of the present disclosure in reference to FIG. 7 provides a use-case wherein the user 702 requests services from the service exchange 706 for the first time. The user 702 sends a request for data (contact numbers) via network 710 to the service exchange 706. In response to the user 702 request for contact numbers, the service exchange 706 transmits any amount of contact numbers necessary pertaining to the request. For example, the service provider 706 responds to the user's request by serving three contact numbers for three separate business providers 704 to the user 702: 1.) Ad-text1, Oa1, Ca1; 2.) Ad-text2, Oa2, Ca2; and 3.) Ad-text3, Oa3, Ca3, Oa1 and Ca1 stand for obfuscated contact numbers and real contact numbers of the business service provider (advertiser) 704. Ad-text stands for advertisement text that has originated from the business service provider 704 and has been transmitted to the service exchange 706. Oa2, Ca2 and Oa3, Ca3 provide similar representations. The service exchange 706, either prior, subsequently or simultaneously, registers the following information with the database 708: 1.) Cu1, Oa1, Ca1; 2.) Cu1, Oa2, Ca2; and 3.) Cu1, Oa3, Ca3, Cu1 stands for the contact number of the user. Cu1 and Oa1 are stored in the database 708 as a pair. All other pairs, Cu1, Oa2 and Cu1 and Oa3 are also stored in the database 708.

In view of FIG. 7, another non-limiting example of a use-case depicts where the user 702 calls one of the obfuscated numbers already served by the service exchange 706 from an earlier request. The user 702 calls Oa2 (an obfuscated contact number as discussed in the above example for a second business service provider 706) which has already been served by the service exchange 706 in response to the user's 702 prior request for information. The service exchange 706 interprets Oa2 as a real contact number Ca2, as it has already stored the context of its earlier reply to the user 702. The service exchange then searches the database 708 using the pair: Cu1, Oa2 (Cu1 contact number of the user 702), and retrieves Ca2 (the advertisers original contact number). The service exchange 706 subsequently connects the user 702 (Cu1) with the business service provider 704 via Ca2.

The interaction between the user 702, service exchange 706, database 708 and business service provider 704 establish a connection between the two parties which provides a more scalable and extendable system 700, in that an abundance of obfuscated numbers can be associated for each customer (user 702). For example, if the service exchange 706 has N obfuscated numbers, it can then associate all N numbers with each customer (user 702).

As noted above with reference to FIG. 1, the system 100 may be realized in a variety of ways combining computer hardware and software. In particular, the system may be embodied in one or more computer processors or a server; for the purposes of this disclosure, a server is software, hardware, or firmware (or combinations thereof) capable of performing the described functions disclosed and claimed herein. A server may be a single server or a group of servers acting together. The server may or may not be embodied as one system or as multiple parts of a distributed system, or as sub-systems of one or the other engines or systems described herein. A number of program modules and data files may be stored on a computer readable medium of the server. They may include an operating system suitable for controlling the operation of a networked server computer, such as the WINDOWS XP or WINDOWS 2000 operating systems from MICROSOFT CORPORATION.

Computer data, as described in this disclosure, may include without limitation executable code as well as user and advertiser contact information and information relating to user/advertiser transactions. For the purposes of this disclosure a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In an embodiment the system 100 executes software downloaded over a network. Such a network may be an intranet (a private version of the Internet). An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

For the purposes of this disclosure a computing device, on which system 100 may be realized, includes a processor or plurality of processors and memory for storing and executing program code, data and software. Computing devices may be provided with operating systems that allow the execution of software applications in order to manipulate data. Personal computers, PDAs, wireless devices, cell phones, internet appliances media players, home theater systems, and media centers are several non-limiting examples of computing devices.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, the analysis described with respect to FIGS. 4 and 6 may be performed in a variety of ways to present the desired information.

Numerous other changes may be made that will readily suggest themselves to those skilled in the art and which are encompassed in the spirit of the invention disclosed and as defined in the appended claims.

What is claimed is:

1. A method comprising:
transmitting a search request to a service provider comprising a user query for contact information for a business provider;
receiving a result from the service provider comprising a contact number and content related to the business provider, the contact number being different from a true contact number for the business provider;
connecting with the business provider via the service provider using the different contact number, wherein the service provider establishes the connection between a user and the business provider; and
communicating with the business provider, the communication being analyzed by the service provider.

2. The method of claim 1, wherein said transmitting of the search request comprises a voice call or an SMS communication.

3. The method of claim 1, wherein the query relates to search for a plurality of business providers.

4. The method of claim 1, wherein the received content relates to advertising content.

5. The method of claim 1, wherein said connection further comprises:
the service provider connecting to the business provider using the true contact number.

6. A method comprising:
receiving at a service provider a contact request from a first party and a second party, wherein the first party and the second party each reveal true contact information, the request pertaining to a distribution of content;
assigning a transactional contact number to the second party that is different from the true contact information of the second party for use by the first party to establish communication between the parties;
assigning an expiration time for the transactional contact number based upon the request;
facilitating a connection between the first party and the second party, wherein the first party utilizes the transactional contact number to contact the second party at least in part via the service provider; and
receiving information related to the communication between the parties to obtain outcome information regarding an outcome of a transaction, wherein the true contact information of either party is not disclosed to either party by the service provider.

7. The method of claim 6, wherein said expiration time is assigned in accordance with a commission paid by a party.

8. The method of claim 6, wherein said expiration time is assigned in accordance with a type of good or service requested by a party.

9. The method of claim 6, wherein said expiration time is assigned in accordance with a requirement expressed by a party.

10. The method of claim 6, wherein said expiration time is assigned in accordance with a characteristic of the transaction.

11. The method of claim 6, further comprising:
extending said expiration time in an event of an incomplete transaction between the parties prior to a conclusion of the expiration time.

12. The method of claim 6, further comprising:
causing expiration of said contact numbers in an absence of a communication between the parties before said expiration time.

13. The method of claim 6, wherein the assigned transactional contact number for the second party is an obfuscated contact number.

14. The method of claim 6, wherein the first party is a user and the second party is a business entity.

15. The method of claim 14, wherein said request from the user is a text message via a Short Message System (SMS).

16. The method of claim 6, further comprising:
extracting information regarding context of the transaction during the communication between the first party and the second party in accordance with said receiving; and
reporting the context to the business entity.

17. The method of claim 14, wherein said communication from the user is a telephone call including voice data, and further comprising:
recording the telephone call; and
converting the voice data to text data.

18. The method of claim 16, wherein said context comprises an advertising keyword.

19. The method of claim 16, wherein said context comprises time and location information relating to said communication with the first party.

20. The method of claim 16, wherein said context comprises the outcome of the transaction.

21. The method of claim 16, wherein said reporting is performed in accordance with a prior arrangement with the second party.

22. A computer readable medium tangibly encoding instructions for performing a method, comprising:
receiving at a service provider a contact request from a first party and a second party, wherein the first party and the second party each reveal true contact information, the request pertaining to a distribution of content;
assigning a transactional contact number to the second party that is different from the true contact information of the second party for use by the first party to establish communication between the parties;
assigning an expiration time for the transactional contact number based upon the request;
facilitating a connection between the first party and the second party, wherein the first party utilizes the transactional contact number to contact the second party at least in part via the service provider; and
receiving information related to the communication between the parties to obtain outcome information regarding an outcome of a transaction, wherein the true contact information of either party is not disclosed to either party by the service provider.

23. The computer-readable medium of claim 22, further comprising:
extending said expiration time in an event of an incomplete transaction between the parties prior to a conclusion of the expiration time.

24. The computer-readable medium of claim 22, further comprising:
causing expiration of said contact numbers in an absence of a communication between the parties before the expiration time.

25. The computer-readable medium of claim 22, further comprising:
extracting information regarding context of the transaction during the communication between the first party and the second party in accordance with said receiving; and
reporting the context to the business entity.

26. A system comprising:
a plurality of processors;
a service provider server for receiving a contact request from a first party and a second party, wherein the first party and the second party each reveal true contact information, the request pertaining to a distribution of content;
a contact number assignment engine implemented on one of the plurality of processors for assigning a transactional contact number to the second party that is different from the true contact information of the second party for use by the first party to establish communication between the parties;
the contact number assignment engine implemented on one of the plurality of processors for assigning an expiration time for the transactional contact number based upon the request;
the service provider server for facilitating a connection between the first party and the second party, wherein the first party utilizes the transactional contact number to contact the second party at least in part via the service provider server; and
a monitoring engine implemented on one of the plurality of processors for receiving information related to the communication between the parties to obtain outcome information regarding an outcome of a transaction, wherein the true contact information of either party is not disclosed to either party by the service provider server.

27. The system of claim 26, further comprising:
a modem for receiving voice data.

28. The system of claim 26 further comprising:
a database storing the information received by the monitoring engine and storing the true contact information for the first party and the second party.

29. The system of claim 26, wherein the monitoring engine is configured to extract information regarding context of the transaction during the communication between the first party and the second party.
